(19) United States
(12) Patent Application Publication
(10) Pub. No.: US 2009/0038877 A1
(43) Pub. Date: Feb. 12, 2009

(54) Electrical steering device for motor vehicles

(75) Inventors: Norbert Willmann, Eisenbach (DE); Bernd Enzmann, Villingen-Schwenningen (DE); Stephan Oberle, Villingen-Schwenningen (DE)

Correspondence Address: THE NATH LAW GROUP, 112 South West Street, Alexandria, VA, 22314, US

(73) Assignee: IMS GEAR GmbH, Eisenbach (DE)

(21) Appl. No.: 12/219,725

(22) Filed: Jul. 28, 2008

(30) Foreign Application Priority Data
Jul. 30, 2007 (DE) 102007035970.7-21

(51) Int. Cl. B62D 3/02; B62D 5/04

(52) U.S. Cl. 180/444; 280/93.513

(57) ABSTRACT

The invention relates to an electrical steering device having a ring gear arrangement made of one ring gear (31), at least one flange (32), and at least one damper that couples the ring gear (31) and flange (32), wherein either the damper has a single damper element that is made of metal or that has metal components, or is made of at least a first damper element (34) and at least a second damper element (35; 35°; 35*), the two damper elements (34, 35; 34, 35°; 34, 35*) having different elasticities. The first damper element (34) has a non-linear spring characteristic line (h(34)) and the second damper element (35; 35°; 35*) has a linear or almost linear spring characteristic line (h(35)).

The invention relates to an electrical steering device for motor vehicles having the features in the preamble in accordance with patent claim 1.

DE 100 56 133 A1 describes an electrical steering device for motor vehicles as it is roughly depicted using FIG. 9. Normally such steering devices have rack-and-pinion steering. An input shaft 2 that is mechanically linked to a steering wheel 4 supports a drive pinion in the rack-and-pinion steering, the drive pinion being engaged with a rack in the rack-and-pinion steering 1. The rack, together with two drag rods 5 and 6, forms an output member that is mechanically linked to wheels to be steered (not shown). The rack also forms the drive part of the steering system. A steering torque can be transmitted from the steering wheel 4 to the wheels to be steered using such a steering device. An electric motor 7 that exerts an assisting torque on the input shaft 2 assists the steering. The electric motor 7 is preferably arranged such that its axis is perpendicular to the axis of the input shaft 2 and thus to that of the drive pinion. However, other angle configurations are also possible. The electric motor 7 drives a worm wheel 30 via a worm 13 in order to transmit an assisting torque to the drive shaft 2 via the worm wheel 30. The drive shaft 2 leads centrally through the worm wheel 30 along an axis X as axis of rotation.

The force and torque are transmitted indirectly between the drive shaft 2 and the worm wheel 30 via an interposed damper that is made of two elastic spacers as two damper elements. The two damper elements are largely annular. A damping effect occurs due to the use of a very soft elastic material such as rubber. The two annular segments of the two damper elements each have radially outwardly oriented projections that engage in ring gear recesses that are embodied on the inside and lateral surfaces of the ring gear 30. This results in high elastic damping both in the radial direction and in the circumferential direction.

Although such decoupled ring gears provide both good force transmission and increased driving comfort, there are also disadvantages.

Normally damping should act very progressively in the torsional direction, especially stop damping for ring gear cams. However, at the null point of a corresponding error characteristic curve the damping is more likely to be too soft, and it is even possible for a clearance to occur between ring gear and flange. However, this is a significant and very critical aspect for facilitating smooth regulation of motor torque assistance. Therefore a minimum increase in a damping characteristic line around the center position is necessary.

In the radial direction, that is, in the direction of clearance equalization, such a solution is much too hard. Toothing clearance equalization no longer functions correctly because of this.

Damping should function similarly at all temperatures. However, a rubber-like damping material changes its elastic properties such as firmness, restoring behavior, compression set, elasticity, and hysteresis. In order to maintain a zero-clearance torsional damping characteristic line, it is currently necessary to use a disadvantageously high pre-stress or a very high minimum upward slope in the damping characteristic line.

The object of the invention is comprised in suggesting a steering device for motor vehicles that enables acoustic decoupling while also enabling radial elasticity for a pre-stress, in particular a zero-clearance pre-stress, in toothing.

This object is attained using the electrical steering device for motor vehicles having the features in accordance with patent claim 1. Advantageous embodiments are the subject-matter of dependent claims.

Accordingly, preferred is an electric steering device having a ring gear arrangement made of one ring gear, at least one flange, and at least one damper that elastically couples the ring gear and flange or flanges, the damper being made of at least a first damper element and preferably also a second damper element, and the two damper elements having different elasticities.

However, it is also within the framework of the invention to use only a single damper element that is made entirely of metal or that at least has metal components.

Preferred is a device in which the first damper element has a non-linear spring characteristic line and the second damper element has a spring characteristic line that rises in particular linearly or approximately linearly. This results in overall behavior having an improved overall spring characteristic line.

It is preferred when the second damper element and the first damper element together form a spring characteristic line in the shape of a hysteresis having a constant or continuous upward slope, that is, they do not create only a horizontal course in the area of the reversal points. In other words, damper elements are used that in terms of material, configuration, and/or dimensioning form a common spring characteristic line that has a continuously rising course, at least in the central part of the characteristic line.

Combining the non-linear spring characteristic line that is in the usual employment force range or employment torque range for such arrangements and the linear spring characteristic line of the two damper elements surprisingly produces an almost ideal or even ideal spring characteristic line that has a desired minimum upward slope. In particular such a slope is preferably approximately greater than 1 Nm/°, preferably greater than 4-8 Nm/°, in the area of the reversal points for the spring characteristic line. That is, the spring characteristic line has a minimum upward slope with a central linear rise.

Preferred is a device in which the second damper element is made of metal, in particular steel, and/or hard plastic. These materials are particularly easy to machine and at the same time offer a spring characteristic line that is at least almost a straight line.

It is preferred when the second damper element is structured and arranged for centering the at least one flange and the ring gear relative to one another. It is also preferred when the first damper element having an in particular radial elasticity is structured and arranged for causing zero-clearance pre-stress in toothing of the ring gear.

The second damper element can preferably be made of a bent spring steel that is easy to machine.

The damper element can preferably be made of an annular, in particular closed continuously annular, segment and projections, the projections projecting radially from the annular segment into ring gear recesses of the ring gear.

Preferred is a device in which the projections are T-shaped, in particular T-shaped with terminal segments running back radially.

The projections can also be made of radially running spring elements and transverse segments placed thereon that run transversely and radially on the outside. Thus, this embodiment does not involve integral projections, in particular does not involve projections integral with the annular segment.

The projections can be placed on, in particular can be securely attached to, the annular segment, rather than being embodied integral with the annular segment embodied projections.

Projections that are made of segments injection-molded in the axial direction of the ring gear and the at least one flange or are made of bent segments that are simple to produce.

Preferred is a device in which the first damper element and the second damper element are embodied as two independent components, the first damper element being arranged between the ring gear and the flange and the second damper element being arranged between the ring gear and a second flange.

Furthermore preferred is a device in which the second damper element is embodied as a metal spring, in particular a steel spring having projections that project radially into ring gear recesses with a greater progression into the limit positions than the first damper element. The separate damper element can be replaced thereby. It is also possible to employ a damper that is embodied as a combined metal-elastomer damper.

In general such a device offers a number of different aspects that individually provide advantages. Using the configuration in accordance with the preferred embodiments, tasks are separated among different components, whereby it is possible to attain stop damping with elastomer and centering with a spring element. The center area can be very precisely adjusted with a constant spring rate. Preferably no clearance should occur with a zero-crossing through the spring characteristic line. Furthermore useful is insensitivity to temperature. The spring characteristic line should preferably not weaken over the service life or time of remaining usefulness.

Even more advantageously supported are methods for preventing unnecessary retention of minimum rises in the damping characteristic line about the corresponding center position, which would have an unnecessary negative effect on the radical stiffness. Ultimately decoupling is advantageously attained in a radial and torsional spring effect.

Corresponding exemplary embodiments in terms of springs, especially steel springs, of plastic springs, etc. can be used in practice. Possibilities for configuring the damper element can include steel springs, plastic springs, steel springs with plastic coatings, combined steel-elastomer dampers, and a steel spring with greater progression in the terminal positions.

One exemplary embodiment and modifications are explained in greater detail in the following using the drawing. The same reference numbers are used for identical components or components that have an identical effect. In particular, to avoid repetition in the description of different embodiments, refer to the description of the other embodiments when components and functions are not altered.

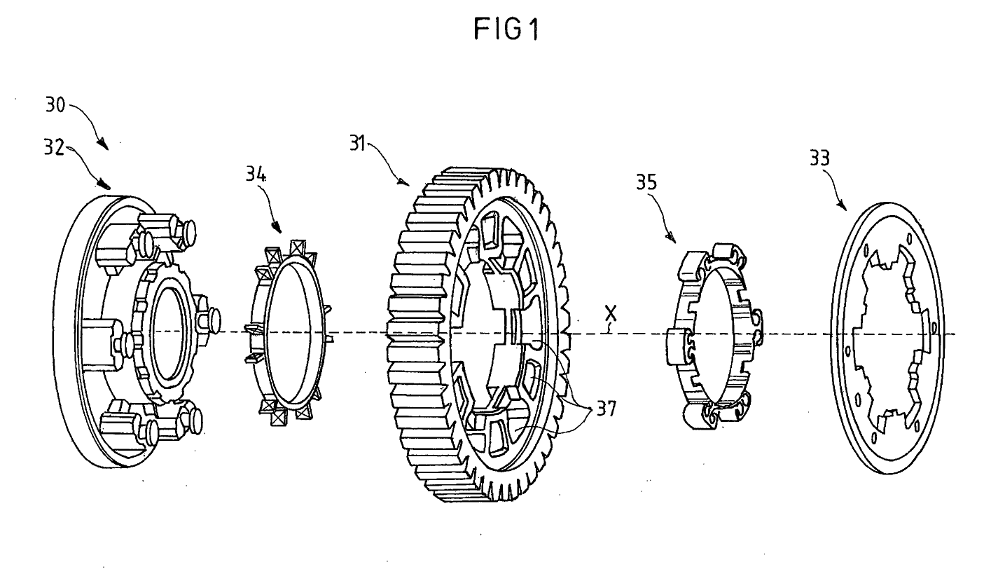

FIG. 1 is an exploded depiction of a ring gear arrangement in accordance with a first embodiment;

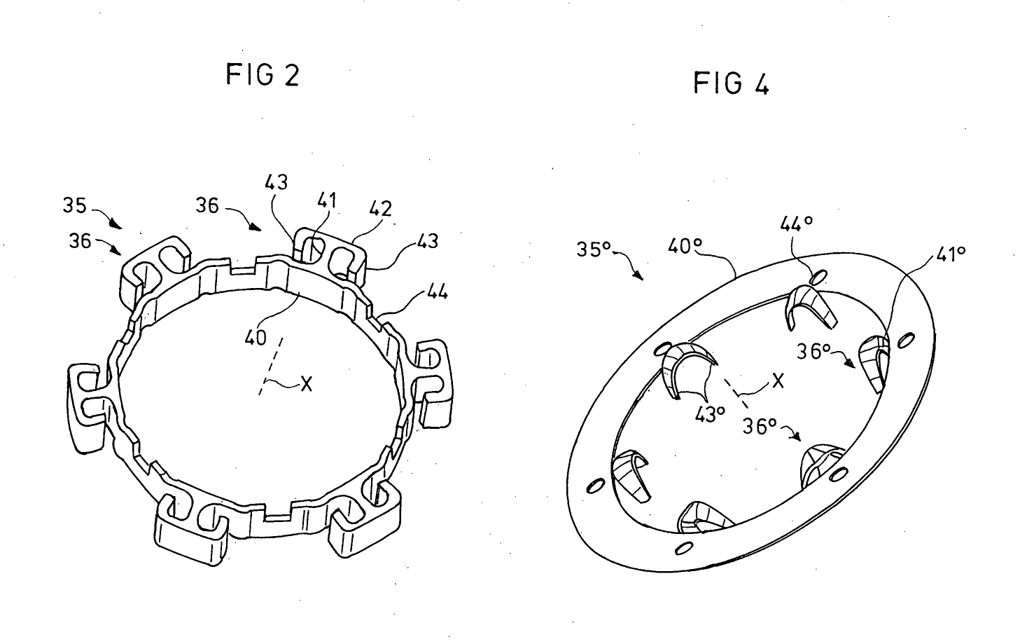

FIG. 2 depicts a second damper element for such an arrangement;

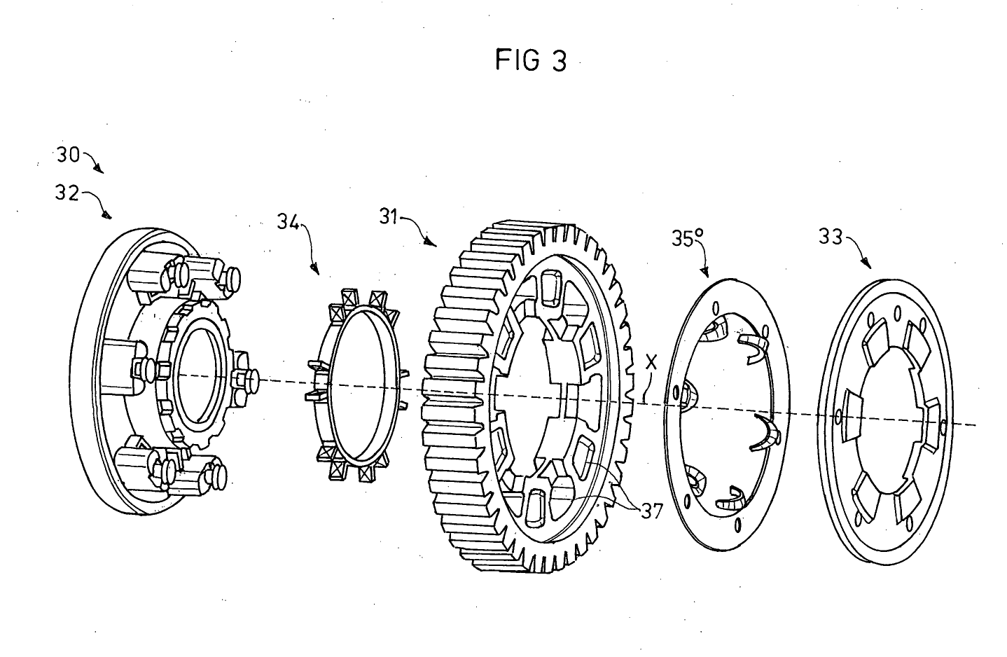

FIG. 3 is an exploded depiction of a second embodiment having a modified second damper element;

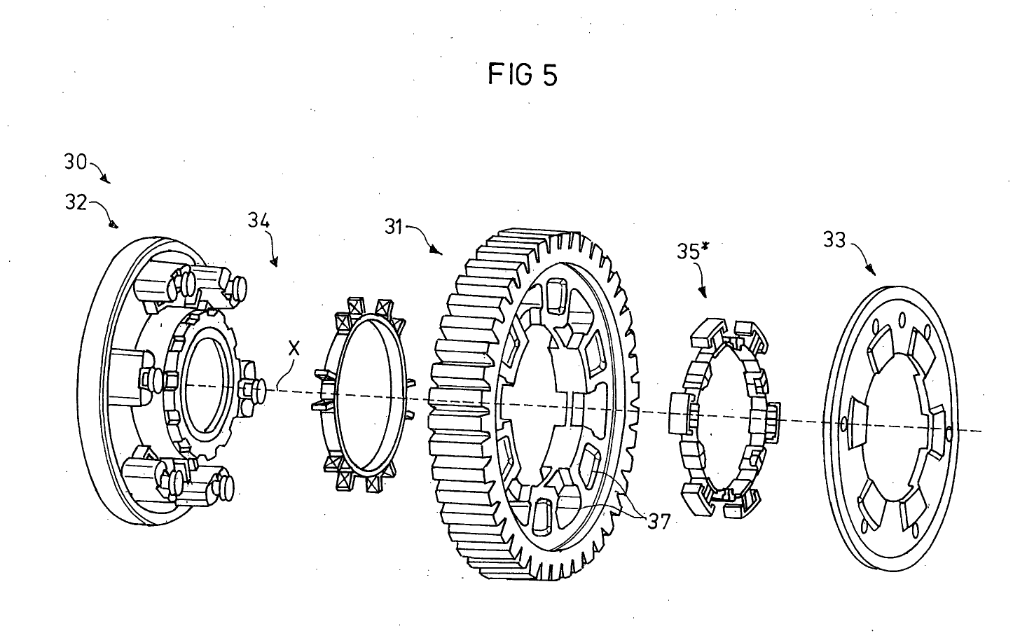

FIG. 4 depicts such a modified damper element;

FIG. 5 is an exploded depiction of a second modified embodiment;

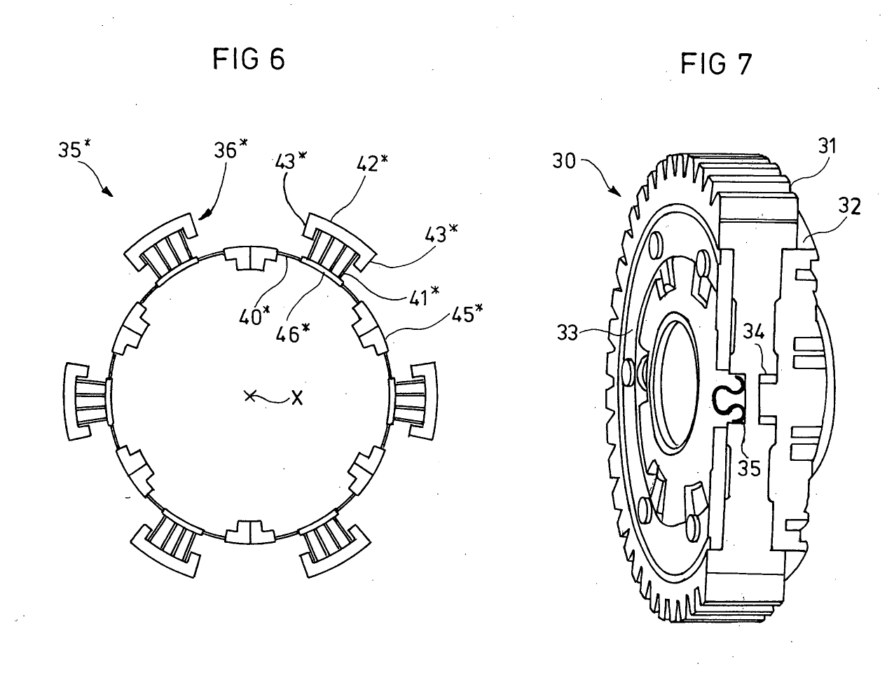

FIG. 6 depicts the corresponding second damper element for this additional modified embodiment;

FIG. 7 is a lateral sectional view through such a ring gear arrangement;

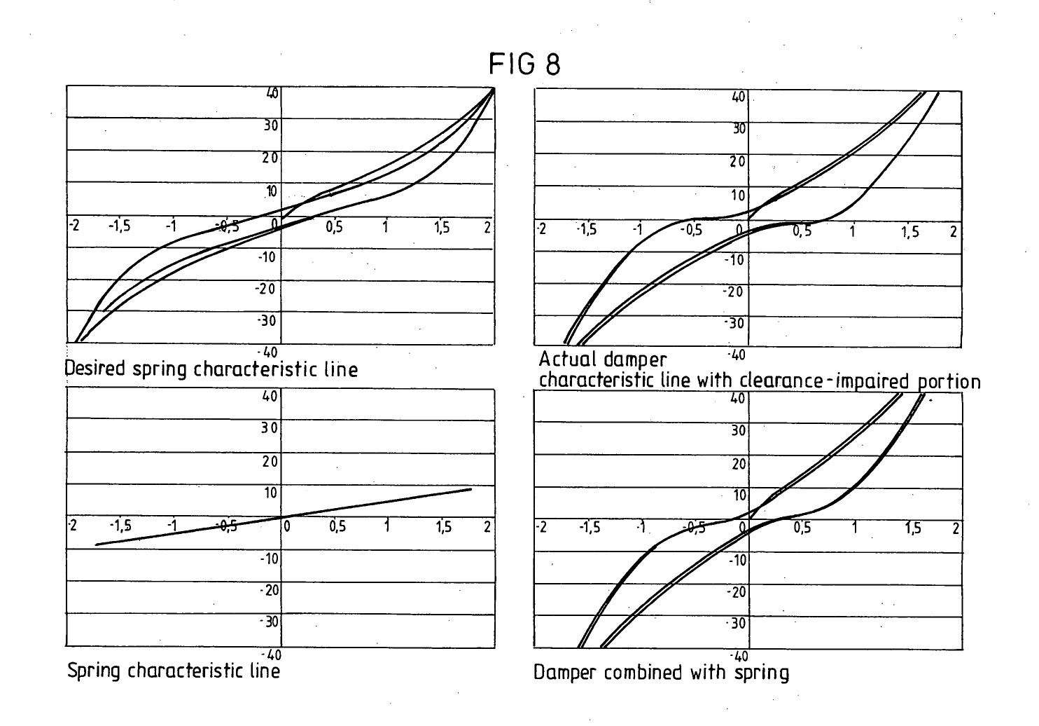

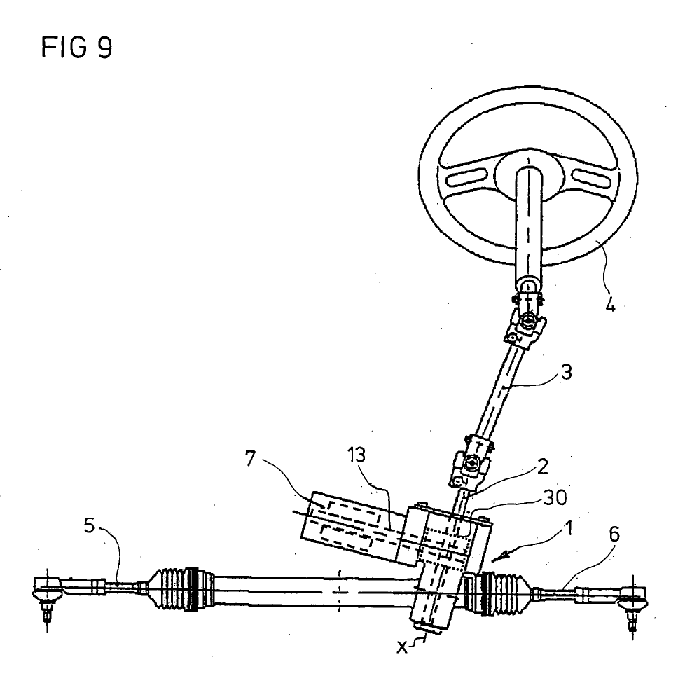

FIG. 8 depicts four sample spring characteristic lines for different damper elements or combinations of damper elements; and

FIG. 9 depicts individual components in an electrical steering device in accordance with the prior art.

FIG. 1 depicts as the central element a ring gear 31 for a central toothed wheel. Embodied on the inside of the ring gear 31 is a passage for a drive shaft 2 to pass through. In addition, provided in the segment between the passage and the outside of the ring gear 31 are structures, in particular ring gear recesses 37 or ring gear openings that engage or grip flange elements of a flange 32 and where necessary of an additional flange 33. Thus the ring gear 31 is a complexly designed component and not just the embodiment of an outside circumferential area.

In the preferred embodiment, the flange 32 and the additional flange 33 are arranged with their central axes of rotation coincident with the axis X for the ring gear 31. The flange 32 and the additional flange 33 are arranged engaging one another with their corresponding flange elements when the two opposing lateral sides of the ring gear are assembled. The drive shaft passes through corresponding openings in the flange 32 and in the additional flange 33 and is rotationally mechanically linked to the flange 32 and/or to the additional flange 33 for transmitting torque between the flange 32 and the additional flange 33 on the one hand and the drive shaft on the other hand.

For coupling the flange 32 and the additional flange 33 to the ring gear 31 and for transmitting torque between them, a first damper element 34 is inserted between the flange 32 and the ring gear 31 and a second damper element 35 is inserted between the additional flange 33 and the ring gear 31. The two damper elements 34, 35 largely comprise annular segments with projections that project radially to the outside. The projections engage in corresponding ring gear recesses 37 and transmit torque when the drive shaft or ring gear 31 rotates. The first damper element 34 is made of a highly elastic material, for instance rubber, and provides damping. In contrast, the second damper element 35 is made of a firmer material having a different elasticity and firmness. The second damper element 35 is preferably made of metal, in particular spring steel, or extruded plastic.

FIG. 8 depicts exemplary spring characteristic lines. A desired ideal damping characteristic line or spring characteristic line h is depicted at the top left. A spring characteristic line h(34) or damping characteristic line that results when two such first damper elements 34 are used is depicted at the top right. A horizontal course is quite evident in the area of the reversal points u for the spring characteristic line h(34) embodied as a hysteresis. In such toothed wheel arrangements, however, disturbing noises and the additional aforesaid disadvantages still result due to this horizontal course.

A spring characteristic line h(35) that has an ideal straight and rising course is depicted on the bottom left. Such a spring characteristic line h(35) can be attained with an ideal elastic spring that is made of a hard spring element. Such a hard spring arrangement would not provide adequate damping, however.

However, surprisingly a spring characteristic line h having a continuous sloping course can also be attained at the reversal points u in that in such a toothed wheel arrangement both a first damper element 34 and also a second damper element 35 are used in combination as dampers. This combination leads to the spring characteristic line h that is depicted in FIG. 8 on the bottom right and that clearly is closer to the desired spring characteristic line.

FIG. 2 provides an enlarged depiction of the second damper element 35 in accordance with the first embodiment. Projecting from a preferably continuous annular segment 40 in the radially outward direction are a plurality of projections 36 that when assembled engage in the corresponding ring gear recesses 37 of the ring gear 31. For enabling rotation-fast engagement in corresponding structures of the ring gear 31 and/or of the additional flange 33, the annular segment 40 has recesses 44 that in the depicted variant lead from one outer side partly into the annular segment 40 and that are rectangular.

The annular segment 40 is preferably embodied in the shape of a narrow partial cylinder.

The preferred projections 36 each comprise a spring element 41 that runs radially outward from the annular segment 40 and a transverse segment 42 on its outside end so that the projections 36 have a T-shape. The transverse segments 42 each preferably run spaced apart from and parallel to the outside circumference of the annular segment 40. In accordance with the particularly preferred embodiment, on the outside the transverse segments 34 transition into terminal segments 43 that run backward or radially back in the direction of the annular segment 40.

In particular the second damper element 35 depicted in FIG. 2 can be produced in a particularly simple manner as a plastic injection-molded part.

FIGS. 3 and 4 depict a second embodiment. The exemplary second damper element 35° in this embodiment is again made from a largely circular segment 40°, and in this embodiment projections 36° oriented radially inward are embodied thereon. The annular segment 40° comprises a flat element having a surface projection perpendicular to the axis of rotation and can be placed laterally on a side wall of the ring gear 31.

When made from sheet or steel sheet, the projections 36° can be shaped in a simple manner by punching in a first step and bending in a further production step. The projections 36° again comprise a first radially running spring element 41, but in this case it runs in the radially inward direction and partly in the axial direction of the axis of rotation. At the end facing away from the annular segment 40° the radially running spring elements 41 again transition into a transverse segment 42° so that a largely T-shaped embodiment results. However, the two lateral segments of each transverse segment 42° are bent such that their outer ends run in a direction parallel to the axis of rotation, at least with a partial directional component. Thus the bent transverse segments 42° can be used in corresponding ring gear recesses 37.

The annular segment 40° also preferably has recesses 44° that are embodied for fixing to the ring gear and/or to the adjacent additional flange 33. The recesses 44° are embodied for instance as bores that pass through the material of the annular segment 40 parallel to the axis of rotation.

FIGS. 5 and 6 depict another embodiment. In this case, the second damper element 35* comprises a plurality of individual components that are attached to one another. The basis again is an annular segment 40* that is preferably cylindrical. Projections 36* are again oriented radially outward. The projections 36* again comprise a spring element 41* that runs radially outward and that is made for instance of folded sheet. Individual ribs run adjacent to one another in the radially outward direction. A plurality of individual such ribs can also be arranged running radially outward instead of one folded individual sheet. Such radially running spring elements 41* can be fastened to the annular segment 40* in a simple manner in that a connecting segment on the one hand receives the radially running spring element or elements 41* securely on the outside and on the other hand is securely connected to the annular segment 40, for instance is placed thereon from the side.

On the outside, the radially running spring element or elements 41 again transition into a transverse segment 42*, the latter again particularly preferred having terminal segments 43* that run back radially. While the annular body 40* and the radially running spring elements 41* are preferably made of a metal material, in particular a steel such as spring steel, the connecting elements 46* for connecting the radially running spring elements 41* and the annular segment 40* as well as the outside transverse segments 42* and their terminal segments 43* are preferably made of hard plastic. The plastic elements can in particular be made using injection molding and where necessary can even securely receive the metal elements during the injection molding.

As an example, additional bent segments or plastic segments that engage in corresponding counter-elements or recesses, in particular of the additional flange 33, can be also be placed on the annular segment 40* as connecting segments.

FIG. 7 depicts a sectional view through an assembled toothed wheel arrangement, a spring element in the shape of such a second damper element 35 being depicted on the left side curved and in section. In contrast, on the opposing right-hand side two segments of the annular rubber-elastic first damper element 34 are depicted in section.

In addition to the depicted embodiments, other differently structured embodiments can be used. In particular it is possible to also configure combinations of the individual elements and designs of the depicted embodiments and to use combinations to create additional embodiments. In addition to the design having two independent damper elements as one elastic spring element and as one in particular metal spring element, combined designs having where necessary even only a single damper element are also conceivable in which the different properties of the first and the second damper elements are provided using a corresponding combined embodiment. In general combinations of the various elements can be created from segments made of metal on the one hand and from segments made of plastic on the other hand.

1. Electrical steering device having a ring gear arrangement made of
one ring gear (31),
at least one flange (32), and
at least one damper that couples said ring gear (31) and flange (32), characterized in that
said damper has at least one damper element (35; 35°; 35*) that is made of metal or that has metal components, or in that
said damper has a first damper element (34) and a second damper element (35; 35°; 35*), each having different elasticity.

2. Device in accordance with claim 1 in which said first damper element (34) has a non-linear spring characteristic line (h(34)) and said second damper element (35; 35°; 35*) has a linear or almost linear spring characteristic line (h(35)).

3. Device in accordance with claim 1, in which said second damper element (35; 35°; 35*) and said first damper element (34) together form a spring characteristic line (h) having a constant or continuous upward slope in the area of the reversal points (u, u).

4. Device in accordance with claim 1, in which said second damper element (35; 35°; 35*) is made of metal, in particular steel, and/or plastic.

5. Device in accordance with claim 1, in which said second damper element (35; 35°; 35*) is structured and arranged for centering said at least one flange (32) and said ring gear (33) relative to one another.

6. Device in accordance with claim 1, in which said first damper element (34) having an in particular radial elasticity is structured and arranged for causing zero-clearance pre-stress in toothing of said ring gear (31).

7. Device in accordance with claim 1, in which said second damper element (35; 35°; 35*) is made of a bent spring steel.

8. Device in accordance with claim 1, in which said second damper element (35; 35°; 35*) in particular closed continuously annular, segment (40; 40°; 40*) and projections (36; 36°; 36*), said projections projecting radially from said annular segment (40; 40°; 40*) into ring gear recesses (37) of said ring gear (31).

9. Device in accordance with claim 8, in which said projections (36; 36*) are T-shaped, in particular T-shaped with terminal segments (42; 42*) running back radially.

10. Device in accordance with claim 9, in which said projections (36; 36*) are made of radially running spring elements (41; 41°; 41*) and transverse segments (42; 42*) placed thereon that run transversely and radially on the outside.

11. Device in accordance with claim 8, in which said projections (36*) are placed on, in particular are securely attached to, said annular segment (40*).

12. Device in accordance with claim 1, in which said projections (36°) are segments (43°) injection-molded in the axial direction (X) of said ring gear (31) and said at least one flange (32) or are made of bent segments (43°) that are simple to produce.

13. Device in accordance with claim 1, in which said first damper element (34) and said second damper element (35; 35°; 35*) are embodied as two independent components, said first damper element being arranged between said ring gear (31) and said flange (32) and said second damper element (35; 35°; 35*) being arranged between said ring gear (31) and a second flange (33).

14. Device in accordance with claim 1, in which said second damper element (35; 35°; 35*) is embodied as a metal spring, in a particular steel spring, with a greater progression of the characteristic line into limit positions.

15. Device in accordance with claim 1, in which said second damper element (35; 35°; 35*) is embodied as a combined part made of metal and elastomer.

16. Device in accordance with claim 2, in which said second damper element (35; 35°; 35*) and said first damper element (34) together form a spring characteristic line (h) having a constant or continuous upward slope in the area of the reversal points (u, u).

17. Device in accordance with claim 3, in which said second damper element (35; 35°; 35*) is structured and arranged for centering said at least one flange (32) and said ring gear (33) relative to one another.

18. Device in accordance with claim 6, in which said second damper element (35; 35°; 35*) in particular closed continuously annular, segment (40; 40°; 40*) and projections (36; 36°; 36*), said projections projecting radially from said annular segment (40; 40°; 40*) into ring gear recesses (37) of said ring gear (31).

19. Device in accordance with claim 10, in which said projections (36*) are placed on, in particular are securely attached to, said annular segment (40*).

20. Device in accordance with claim 9, in which said projections (36°) are segments (43°) injection-molded in the axial direction (X) of said ring gear (31) and said at least one flange (32) or are made of bent segments (43°) that are simple to produce.
